(19) United States
(12) Patent Application Publication
(10) Pub. No.: US 2013/0237230 A1
(43) Pub. Date: Sep. 12, 2013

(54) Reconfiguring a Base Station for Handover in Relay-Enhanced Communication Network

(71) Applicants: Bernhard Raaf, Neuried (DE); Bernhard Wegmann, Holzkirchen (DE); Ingo Viering, Munich (DE); Dirk Rose, Munich (DE)

(72) Inventors: Bernhard Raaf, Neuried (DE); Bernhard Wegmann, Holzkirchen (DE); Ingo Viering, Munich (DE); Dirk Rose, Munich (DE)

(73) Assignee: NOKIA SIEMENS NETWORKS OY, Espoo (FI)

(21) Appl. No.: 13/880,237

(22) PCT Filed: Oct. 19, 2010
(86) PCT No.: PCT/EP2010/065684

§ 371 Date: May 21, 2013

(51) Int. Cl. H04W 36/08

(52) U.S. Cl. CPC H04W 36/08
USPC 455/436

(57) ABSTRACT

There is provided a solution for co-operation in a relay-enhanced communication network, wherein the solution includes receiving, by an auto-configuration apparatus, information about a preference of a relay node to co-operate with a selected base station, and automatically reconfiguring or initiating the reconfigure of the selected base station to serve the relay node as a donor base station when the selected base station does not currently support serving the relay node as the donor base station.

### FIELD

The invention relates generally to mobile communication networks. More particularly, the invention relates to automatically reconfiguring eNBs in order to allow the reconfigured eNB to serve as a donor eNB in a relay-enhanced communication network.

### BACKGROUND

In radio communication networks, such as the Long Term Evolution (LTE) or the LTE-Advanced (LTE-A) of the 3^{rd} Generation Partnership Project (3GPP), network deployment comprises the use of base stations (such as a Node B (NB), or an evolved Node B(eNB)). However, it may be that the coverage areas of the eNBs are insufficient to enable certain user equipments (UE) to communicate properly with any eNB. In order to enable the UE to communicate, the network deployment may be extended by so called relay nodes.

In relay-enhanced communication networks, the transmission may occur from a transmitter to a receiver via a relay node, also known as a relay station. The relay node (RN) may be placed in a cell of the eNB in order to extend the coverage area of the eNB and to increase the capacity/throughput of the cell. Further, the RN may increase the capacity at shadowed areas in the cell as well as in the locations where the traffic demand is high such as in airports or other hot spots, for example. In addition, the RN may be applied to reduce the average radio transmission power of the user equipment attached to the relay node.

The RN must be connected to a certain eNB, called a donor eNB (DeNB). For an eNB to act as the DeNB, the eNB must be properly configured. When the RN desires to connect to an eNB which is not properly configured, problems may occur.

### BRIEF DESCRIPTION OF THE INVENTION

Embodiments of the invention seek to enable the self-organized upgrade of the base station to serve as the donor base station in the relay-enhanced communication network. According to an aspect of the invention, there are provided methods as specified in claims 1 and 10.

According to an aspect of the invention, there are provided apparatuses as specified in claims 12, 21, 23, and 24. According to an aspect of the invention, there are provided computer program products as specified in claims 25 and 26. Embodiments of the invention are defined in the dependent claims.

### LIST OF DRAWINGS

In the following, the invention will be described in greater detail with reference to the embodiments and the accompanying drawings, in which

FIG. 1 presents a communication network;

FIG. 2 shows a relay-enhanced communication network according to an embodiment;

FIGS. 3A, 3B and 3C show communication between a relay node, base station and a centralized network element, according to embodiments;

FIG. 4 illustrates apparatuses capable of performing in the relay-enhanced communication network, according to an embodiment;

FIG. 5 illustrates a method for reconfiguring a base station in the relay-enhanced communication network, according to an embodiment; and

FIG. 6 illustrates a method for reconfiguring a base station in the relay-enhanced communication network, according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a Node B, or an evolved Node B, for example), a user equipment (also called a user terminal and a mobile station, for example) and optional network elements that provide the interconnection towards the core network. The base station connects the UEs via the so-called radio interface to the network.

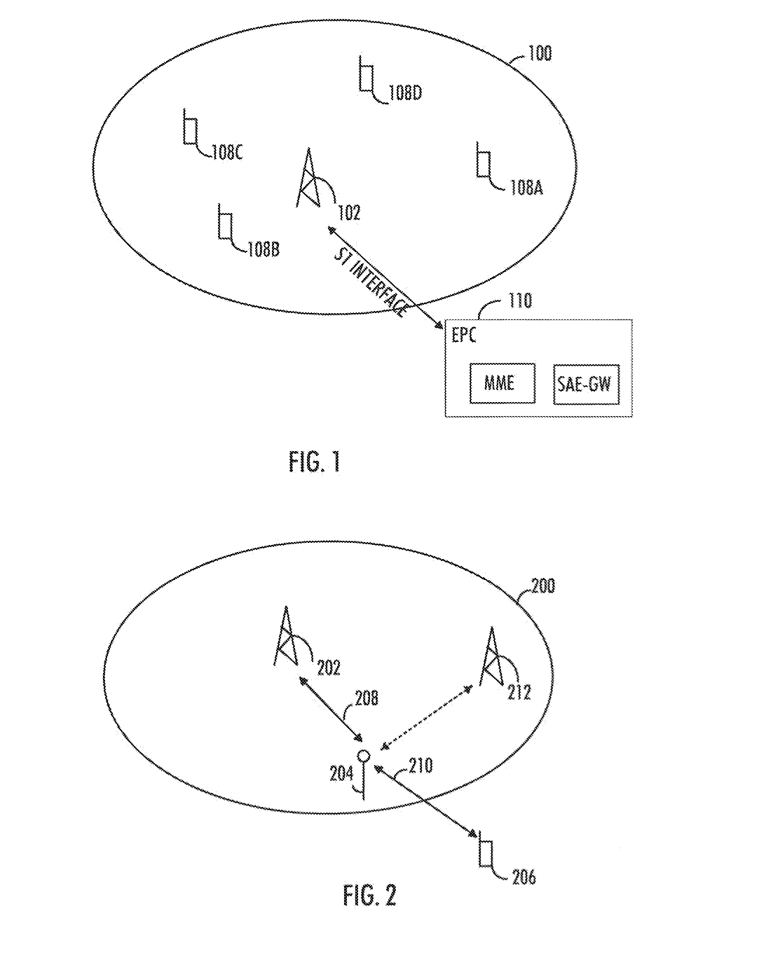

FIG. 1 shows a communication network. As explained, the communication network may comprise a base station 102. The base station 102 may provide radio coverage to a cell 100, control radio resource allocation, perform data and control signaling, etc. The cell 100 may be a macrocell, a microcell, or any other type of cell where radio coverage is present. Further, the cell 100 may be of any size or form, depending on the antenna system utilized.

In general, a base station 102 applicable to the embodiments may be configured to provide communication services according to at least one of the following communication protocols: Worldwide Interoperability for Microwave Access (WiMAX), Universal Mobile Telecommunication System (UMTS) based on basic wideband-code division multiple access (W-CDMA), high-speed packet access (HSPA), LTE, and/or LTE-A. The base station 102 may additionally provide the second generation cellular services based on GSM (Global System for Mobile communications) and/or GPRS (General Packet Radio Service). The present embodiments are not, however, limited to these technologies.

The base station 102 may be used in order to provide radio coverage to the cell 100. The base station 102 may be seen as one communication point of the network. The base station 102 may be node B, evolved node B (eNB) as in LTE-A, a central node, or any other apparatus capable of controlling radio communication and managing radio resources within the cell 100. The base station 102 may also have an effect on mobility management by controlling and analyzing radio signal level measurements performed by a user terminal, carrying out its own measurements and performing handover based on the measurements.

For the sake of simplicity of the description, let us assume that the base station is an eNB. The evolved universal mobile telecommunication's system (UMTS) terrestrial radio access network (E-UTRAN), which comprises the air interface of the LTE, is concentrated on the eNB 102. All radio functionality is terminated here so that the eNB 102 is the terminating point for all radio related protocols. The E-UTRAN may be configured such that orthogonal frequency division multiple access (OFDMA) is applied in downlink transmission, whereas single carrier frequency division multiple access (SC-FDMA) may be applied in uplink, for example. In the case of multiple eNBs in the communication network, the eNBs may be connected to each other with an X2 interface as specified in the LTE.

The eNB 102 may be further connected via an S1 interface to an evolved packet core (EPC) 110, more specifically to a mobility management entity (MME) and to a system architecture evolution gateway (SAE-GW). The MME handles/terminates the control plane for controlling functions of non-access stratum signal-ing, roaming, authentication, tracking area list management, etc., whereas the SAE-GW handles user plane functions including packet routing and forward-ing, E-UTRAN idle mode packet buffering, etc. The user plane bypasses the MME plane directly to the SAE-GW. The SAE-GW may comprise two separate gateways: a serving gateway (S-GW) and a packet data network gateway (P-GW). The MME controls the tunneling between the eNB and the S-GW, which serves as a local anchor point for the mobility between different eNBs, for ex-ample. The S-GW may relay the data between the eNB and the P-GW, or buffer data packets if needed so as to release them after appropriate tunneling has been established to a corresponding eNB. Further, the MMES and the SAE-GWs may be pooled so that a set of MMES and SAE-GWs may be as-signed to serve a set of eNBs. This means that an eNB may be connected to multiple MMES and SAE-GWs, although each user terminal is served by one MME and/or S-GW at a time.

According to an embodiment, the eNB 102 may establish a connection with a user equipment (UE) 108A to 108D such as a mobile user terminal, a palm computer, or any other apparatus capable of operating in a mobile communication network. That is, the UE 108A to 108D may perform data communication with the eNB 102.

When the UE 108A to 108D is out of reach of the eNB 102, it may be advisable to implement relay nodes to the network. FIG. 2 illustrates a relay enhanced communication network, according to an embodiment, in which an eNB 202 provides radio coverage to a cell 200. In addition there are one or more relay nodes (RN) 204 in the cell for enhancing the coverage/capacity of the cell 202. A UE 206 may thus communicate with the eNB 202 via the RN 204.

The link 208 between the eNB 202 and the RN 204 may be called a relay link or a backhaul link, and the link 210 between the RN 204 and the UE 206 may be called an access link. Although not shown in FIG. 2, the eNB 202 may also serve additional UEs via a direct link between the eNB 202 and each of the served UEs.

There are various relay transmission schemes that can be employed. In an amplify-and-forward protocol an amplify-and-forward relay node first receives a signal from the source node, then scales the power of the signal up or down and finally forwards the signal towards a target. Another exemplary relaying protocol applies selective decode-and-forward method, in which the received data at the relay node is decoded and re-transmitted to the target only if the data is correctly received through cyclic redundancy check or a similar error detecting code. A demodulate-and-forward relay scheme performs a hard decision of the received, demodulated, symbol at the relay node at a first phase and then modulates and forwards the data to the target.

It may be that the eNB 202 is not the most optimal eNB to use in the data communication in terms of radio channel conditions, for example. However, in the original network planning, the eNB 202 may have been set as the only eNB in the area that is capable of co-operating with a relay node as the donor eNB.

Let us assume that there is an eNB 212 in the network of FIG. 2. The eNB 212 may provide radio coverage to the same cell 200 or to another cell which is possibly overlapping the cell 200. This eNB 212 may provide, for example, better radio communication conditions to the relay node 206 than the eNB 202. The radio communication conditions may characterize radio propagation channel between the RN 204 and the eNB 202 and/or the eNB 212. Therefore, it may be advisable to use this eNB 212 as the donor eNB (DeNB) instead of connecting to the eNB 202 that offers poor radio conditions to/from the RN 204. However, due to the original network planning, this may not be possible as the eNB 212 is not configured to perform functionalities required when co-operating with a relay node. That is, based on the original network planning, the RN 204 may connect only to the eNB 202 that already comprises the required DeNB functionalities for the co-operation. These functionalities may comprise, for example, proxy functionalities and gateway-like functionalities. The proxy functionalities allow hiding the RNs 204 from MMEs/GWs serving the UEs. That is, the RN 204 is seen as a new cell under the DeNB (eNB). The DeNB appears to the RN 204 as an MME (S1 interface) and as an eNB (X2 interface). The gateway-like functionalities comprise creating sessions or managing evolved packet system (EPS) bearers for the RN 204. In other words, these functionalities are needed from an eNB in order for the eNB to be a DeNB and to co-operate with the relay node.

It may be that the RNs are not considered in the initial network planning (roll-out), but are interesting to network operators for enhancing the network later, because they are simple and cost-effective. Therefore, in the initial roll-out phase eNBs are not necessarily configured as DeNBs, at least not all of the eNBs 202 and 212. In the assumed example, when the relay node 204 prefers to co-operate with the eNB 212 as shown with a dotted line in FIG. 2, the eNB 212 may have to be upgraded (reconfigured) to be able to perform the functionalities as required from a DeNB (eNB). This type of re-configuration may result in quite a lot of effort with respect to at least the following aspects: a new planning phase may need to be launched to determine the best serving eNB, which may in turn require that the detailed position of the RN has to be known in advance and also the details of the radio propagation environment between the RN and the existing eNBs, including small scale effects due to buildings, trees, etc, need to be known.

As the RNs provide an efficient solution to enhance the network, it may be advisable that any upgrade, extension or replacement of hardware requires minimal operator attention. Therefore, it is advantageous to perform the possible reconfiguration automatically. This type of self-organizing network (SON), where the reconfiguration is performed automatically without any operator attention and any re-planning of the communication network, may result in that the relay nodes may be set up in a plug and play-manner. This automated process eliminates the need for manually upgrading (or planning) the eNB to DeNB prior to the RN deployment.

Accordingly, there is provided a self-organized upgrade of an eNB 212 to comprise the functionalities as required from a DeNB. In an embodiment, the relay node 204 selects a base station 212 to co-operate with, wherein the selection is made among at least one base station 202 and 212 on the basis of available radio channel conditions. The relay node 204 may measure the condition of the radio channel to each of the at least one base station 202, 212 and perform the selection on the basis of the measurement performed. The radio channel condition characterizes the propagation channel between the relay node 204 and the corresponding eNB 202/212. The measurement may take the shadowing and small-scale fading between the RN 204 and the eNB 202/212 into account. The measurement of the radio channel condition may be made by the RN 204 in the same way as a user equipment in the communication network typically measures the received signal power strength when deciding which eNB to connect to, for example. In this sense, when the RN 204 is switched on, it will behave like an UE looking for best server (an eNB with the best signal strength). The scheme may, however, be generalized to other cell selection criteria taking more aspects into account e.g. interference levels, load at the eNB, expected positions of further relay nodes, etc.

Once the RN 204 has selected the eNB 212 to co-operate with, the RN 204 may inform an auto-configuration apparatus (ACA) about a preference of the relay node 204 to co-operate with the selected eNB 212 in order for the auto-configuration apparatus to automatically reconfigure or to initiate the reconfiguration of the selected eNB 212 to serve as the donor eNB when the selected eNB 212 does not currently support serving the relay node as the donor eNB. If the selected eNB 212 already supports relay node co-operation with respect to the DeNB functionalities as described earlier, the auto-configuration apparatus (ACA) need not perform any re-configuration in the relay-enhanced communication network.

In an embodiment, the reconfiguration of the eNB 212 is not performed to an eNB already capable of serving the relay node as the donor eNB, but only to an eNB that is not capable of co-operating with a relay node in terms of the above described functionalities. Therefore re-configuring an already performing DeNB for certain specific purpose is not the aim of the reconfiguration.

In another embodiment, the RN 204 selects at least one additional base station, wherein the at least two selected base stations 202 and 212 are candidate base stations for co-operation with the relay node 204. Therefore, a list of possible eNBs that could serve as DeNB may be sent to the ACA. Again, the selection of the candidate eNBs may be based on the available radio channel conditions or the selection may take further aspects into account. The RN 204 may select, for example, four different eNBs which all are suitable for co-operation in terms of sufficiently adequate radio channel conditions. In the exemplary case of FIG. 2, the RN 204 may select the eNBs 202 and 212 as the candidate eNB for co-operating with the RN 204.

Consequently, the eNB 204 may inform the ACA of the candidate eNBs 202 and 212 in order to allow the ACA to select which of the candidate eNB 202 and 212 is to serve the RN 204 as the donor eNB, and to automatically reconfigure or initiate the reconfiguration of the selected eNB 212 when the selected eNB 212 does not currently support serving the RN 204 as the donor eNB, assuming that the ACA selected the eNB 212 to be the DeNB for the RN 204. The selection at the ACA may be based on at least one of the following reasons related to the at least two selected eNB 202 and 212: indicated radio channel conditions, a current traffic situation, expected positions of further relay nodes, and original network planning. That is, in this example, the RN 204 may have indicated the measured radio channel conditions to the ACA so that the ACA may perform a sophisticated selection. The indication may inform the ACA what the quality of the link to the different eNBs 202, 212 is, in order to allow the ACA to prefer those eNBs with better links. Moreover, the ACA may be aware of the current traffic (load) situation in the relay-enhanced network. The ACA may also know if certain eNBs are reserved for some specific purposes which prevent those eNBs to be reconfigured as DeNB. In the simplest case however the ACA may not get any such supporting information and still may decide to reconfigure at least one of those eNBs, e.g. based on the number of RNs in the area. When taking the existing RNs or expectations of future RNs to be deployed in the area into account, the ACA may take care that preferably such an eNB is upgraded that can be expected to later also serve other RNs which are expected to be deployed. In this way the number of required future updates and associated cost can be reduced. The base station may have knowledge of the expected locations of further relay nodes as part of the original network deployment information, or it may obtain the knowledge from other network elements, operators, etc.

As the ACA may be aware of at least these reasons for selection, the ACA my prioritize the current traffic situation and the original network planning over the indicated radio channel conditions when selecting which of the candidate base stations is to serve the relay node. That is, when the eNB 212 with the best available radio channel condition is, for example, a legacy eNB that does not allow to be upgraded, or the eNB 212 is heavily loaded with traffic (either on the air interface or the backhaul), the ACA may not select the eNB 212 (which has the best radio channel conditions) but select the eNB 202 (which does not have the best, yet adequate, radio channel properties) to be the DeNB for the RN 204. If the eNB 202 is already capable of performing as the DeNB, no reconfiguration is needed.

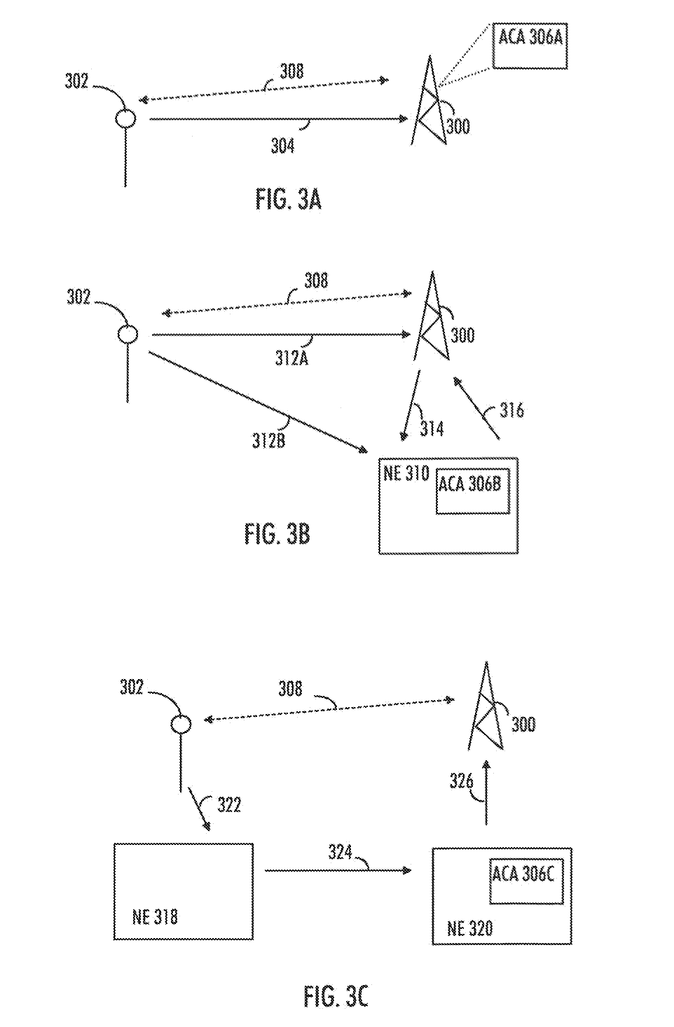

Let us take a look at how the informing of the preference to co-operate with a certain eNB to the ACA may take place. In embodiments of FIGS. 3A, 3B and 3C, the RN 302 has selected the eNB to co-operate with or provided information that allows another entity to select that eNB. As a consequence, the ACA 306 (306A, 306B, or 306C) is informed accordingly of this.

In FIG. 3A, the selected eNB 300 receives this information about a preference of the relay node 302 to co-operate with a selected base station 300. This may happen so that the RN 302 uses the air interface 304 of selected eNB 300 to send a message to the ACA 306A. The message may also contain an indication that the sender of the message is a relay node 302 (not a UE). In the example of FIG. 3A, the ACA 306A locates at the selected eNB 300. Consequently, the ACA 306A may then automatically reconfigure or initiate the re-configuration of the selected base station 300 when the selected base station 300 does not currently support serving the relay node 302 as the donor eNB. In other words, the selected base station 300 may automatically reconfigure itself to serve as the donor eNB in the relay-enhanced communication network. This may take place so that the ACA performs the re-configuration of the selected base station 300, or so that it initiates the reconfiguration process by informing the selected base station 300 to trigger reconfiguration. When the reconfiguration is completed, data communication over the relay link 308 may take place. As the base station 300 now comprises the functionalities as required from a donor base station, the base station 300 may serve any relay node in the relay-enhanced communication network, not only the RN 302 making the co-operation request.

In FIG. 3B, the auto-configuration apparatus 306B locates at another network element 310 than the selected base station 300. The other network element (NE) 310 may be a centralized element in the network, such as a network management system (NMS) element, an operational support system (OSS) element, or an operation and maintenance element (O&M). Alternatively, the other network element 310 may be another eNB other than the selected one.

As the ACA 306B does not locate in the selected eNB 300, the RN 302 may directly inform the ACA 306B of the preference to co-operate with the selected base station 300 via a communication link 312B. The link 312B may be for example a logical link which may physically go via the eNB 300. Alternatively, the RN 302 may via communication links 312A (between the RN 302 and the selected eNB 300) and 314 (between the eNB 300 and the NE 310) indirectly inform the ACA 306B that the RN 302 desires to co-operate with the eNB 300. After the ACA 306B receives the information, it may decide to re-configure or initiate the reconfiguration of the selected eNB 300 when the selected eNB 300 does not currently support serving the RN 302 as the donor eNB. The signaling needed for the reconfiguration may be transmitted via a link 316. That is, the reconfiguration may be triggered not by the eNB 300 itself but by another network entity 310. When the reconfiguration is completed, data communication over the relay link 308 may take place.

As the RN 302 may not have to communicate with the eNB 300 before the reconfiguration, the RN 302 may not send an indication that it is a RN (not a UE) to the to-be-DeNB 300 but directly or indirectly to the NE 310. This allows a more centralized and coordinated approach of performing the reconfigurations. The eNB in this case may be unaware why it is being reconfigured (upgraded)). The advantage of this approach is that then the eNB 300 may not have to implement any additional features to support its upgrade to DeNB. The processing at the eNB 300 may be decreased as the eNB 300 itself does not need to decide whether to perform the reconfiguration or not.

In FIG. 3C, there are two NEs 318 and 320, one 318 for the RN 302 and another 320 for the to-be-DeNB 300. In an embodiment, the RN 302 may inform its own NE 318 via a link 322 about the preference to co-operate with the selected eNB 300. It may be that the NE 318 connected to the RN 302 is incapable to perform the reconfiguration of the eNB 300. Thus, information related to the selected base station 300 may be exchanged with the other network element 320, when the NE 318 is incapable of reconfiguring the selected base station 300, thereby allowing the other network element 320 to reconfigure the selected base station 300. This way, the NE 320 with an ACA 306C receives information via communication link 324 regarding which eNB 300 is to be upgraded to obtain DeNB functionalities. For example, the identification of the eNB 300 can be sent from the NE 318 to the NE 320. The NE 320 may then trigger/perform the reconfiguration via a link 326. When the reconfiguration of the eNB 300 is completed, data communication over the relay link 308 may take place.

When the ACA is not located at the selected eNB but in the other network element 310, as is the case in the example of FIG. 3B, for example, the ACA 306B may receive information of at least one additional base station, wherein the at least two selected base stations are candidate base stations for co-operation with the relay node 302. That is, the ACA 306B may receive a list of candidate eNBs, wherein the relay node 302 plans to co-operate with one of the candidate eNBs but the RN 302 leaves the final selection to the ACA. Then the ACA 306B may select which of the candidate base stations is to serve the relay node as the donor eNB on the basis of at least one of the following reasons (grounds) reflated to the at least two selected base stations: indicated radio channel conditions, a current traffic situation, expected positions of further relay nodes, and original network planning, as discussed above. In selection process, the ACA 306B may apply the prioritization as discussed above. After the selection the ACA 306B may automatically reconfigure or initiate the reconfiguration of the selected base station when the selected base station does not currently support serving the relay node 302 as the donor eNB.

In an embodiment, the ACA 306A, 306B, 306C (from now on commonly referred to as 306), may reconfigure the selected base station 300, wherein the reconfiguration may comprise at least one of the following: updating a software of the selected base station, re-parameterizing the configuration of the selected base station, activating a license to the software, assigning a new physical cell identity to the selected base station, updating a tracking area of the selected base station, and adjusting antenna orientation of the selected base station.

The updated software allows the eNB 300 to perform the functionalities required from a DeNB. These include the proxy functionalities and the gateway-like functionalities, as described earlier. The software may be updated by the ACA or the software update may be initiated by the ACA, e.g. the software may then be downloaded by the eNB itself or uploaded by another apparatus. After the software has been updated, a license for the software may need to be activated. In an embodiment, the license activation may even be required if the software does not need to be updated as the initial software release already does support relaying. In an embodiment, the ACA 306 may verify that the reconfiguration of the selected base station 300 is allowed with respect to licenses. In this sense, the reconfiguration is conditional depending on an authorization with respect to licenses. The verification may be obtained from a license manager apparatus, for example. The license manager apparatus may locate in a centralized unit, such as in the O&M, for example. The ACA 306 may then restrain from the reconfiguration if the reconfiguration is not allowed. This is advantageous in order for operators to inhibit some eNBs to be upgraded to DeNBs. The reason for such may be to have only a subset of the eNBs available for performing as DeNB. The motivation behind this may be to save license costs, for example.

As part of the reconfiguration, a re-parameterization of the configuration of the selected base station may be useful. For example, some memory that may otherwise be used for data buffers may need to be set aside to keep information regarding the served relay nodes. Furthermore, the ACA 306 may give the DeNB a new physical cell identity (PCI) so that the co-operating RN 302 may use that PCI in order to be seen as new cell. The tracking areas of the DeNB may need to be updated. The reconfiguration of the eNB 300 may also comprise adjusting the eNB's 300 antenna orientation, such as tilt values of the antenna. The purpose of this re-orientation may aim at making sure that the RN 302 is within the main beam of the eNB 300. As this depends on the location of the RN 302, and in particular on the height above ground where the relay is deployed, a change in a tilt value (a lower tilt or a higher tilt), and/or possibly a change in the azimuth angle of the antenna may be beneficial depending on the exact location of the RN 302 with respect to the location of the eNB 300. Typically relays are deployed at a higher altitude than normal subscribers are. For example, when deployed on a typical lamp post, the deployment altitude may be above 5 m, whereas typical altitude of a hand held device may be 1.5 m. Therefore, tilt values of the to-be-DeNB that were optimized originally for the handheld devices may need to be revised.

In an embodiment, the ACA 306 may inform the relay node 302 to restrain from the co-operation with the selected base station until the reconfiguration of the selected base station is compete. This may be advantageous because the upgrade of the eNB 300 to obtain the functionalities of a DeNB may take some time, during which the RN 302 may not connect to it as a RN. The time may be needed for downloading new software or licenses or performing other reconfigurations. The time to wait may also be longer than the time required to do the actual reconfiguration if the latter is deferred to a later time, e.g. to be performed during times of low traffic over night. Then it may be beneficial to inform the relay node 302 when the relay node 302 may attempt to co-operate with the selected base station 300. Otherwise the RN 302 may select the next-best eNB, thus possibly creating a sub-optimal setup. The point of time when the RN 302 may try to co-operate with the to-be-DeNB 300 may be indicated as a specific time instant, a given time period during which co-operation may be attempted, or the RN 302 may be instructed to try the co-operation periodically. As a further embodiment, the RN 302 may after some attempts give up and connect to another (next best) eNB, for example.

In an embodiment, there is provided a solution against fake RNs attempting to connect to the eNB 300. When the ACA locates in the selected eNB 300 or the selected eNB 300 itself requests for reconfiguration of the selected eNB 300, the selected eNB 300 is gradually reconfigured so that the selected eNB 300 is first enabled to obtain knowledge of identification (ID) of at least one RN 302 in the relay-enhanced communication network. The identification and possibly verification of the identity of a RN may be done solely by the eNB 300 or in co-operation with other network elements, e.g. the MME or other core network elements. Thus, at this point only a part of the software of the eNB 300 may be updated instead of performing the reconfiguration of eNB to DeNB completely, wherein the updated part of the software contains information enabling the verification of the identities or IDs of the RNs 302 in the network. Typically, the functionality of knowing the IDs is considered to be a functionality of the MME. For this reason, this part of the software of the eNB 300 may be updated to enable this MME functionality or to co-operate with the MME accordingly. This part of the reconfiguration process may be done for each co-operation attempt from a RN, regardless whether the attempting RN is later found to be a fake RN or a valid (genuine) RN.

Thereafter, the eNB 300 may analyze the ID of the relay node 302 attempting to co-operate with the selected eNB 300 in order to verify that the RN 302 is a valid relay node in the relay-enhanced communication network. When the relay node is considered to be invalid, the eNB 300 is not reconfigured any further and the request from the RN 302 to co-operate with the eNB 300 is rejected. However, only when the ID of the RN 302 is a valid ID implying that the RN 302 is a genuine (valid) relay node, the reconfiguration of the eNB 300 is completed. This may take place by updating the rest of the modules of the eNB 300 in order for the eNB 300 to work fully as a DeNB. The rest of the modules that may be upgraded at this point typically comprise a much bigger part of the reconfiguration process than only the updating of the module allowing the ID verification. Thus, those RNs that are not genuine (valid) relay nodes do not trigger the complete re-configuration. This is beneficial so that major part of the reconfiguration process is not done when fake RNs attempt to connect the eNB 300. Furthermore, this may result in saving in the license costs as well, because eNBs are not updated to DeNB for fake RNs.

Alternatively, each eNB 300 in the relay-enhanced communication network which are not yet DeNBs but which are able to upgrade themselves or are able to being upgraded, if needed, may be updated at least for the part allowing the eNB 300 to understand the information from the relay node attempting to co-operate, wherein the information relates to the identification of the relay node. That is, instead of updating part of the software for only those eNB that receive indication of co-operation attempt, the update may be performed for every eNB in the network. The identification by the RN may be given in the form of an international mobile subscriber identity (IMSI), or in the form of an international mobile equipment identification (IMEI), for example. Once the eNB knows the IDs of the RNs in the network, it may restrain from triggering the reconfiguration when the RN is found to be a fake RN. On the other hand, for co-operation attempts from genuine RNs, the reconfiguration process may be started.

When the update is triggered via a centralized network element, 310 or 320, the centralized NE 310, 320 may include the check for genuine RNs in a similar way. The centralized NE 310, 320 may already have the knowledge needed to differentiate fake RNs from valid RNs.

In an embodiment, the ACA may receive information of at least one additional base station. Thus, the ACA receives information of at least two selected base stations. Each of the selected at least two eNBs are to co-operatively serve the RN as DeNBs. This may be the case, for example, in a soft handover, in a co-operative interference management, or in a co-operating transmission/reception where several eNBs co-operate to at least some extent to serve the RN. Then the ACA may automatically reconfigure or initiate the reconfiguration of at least one of the at least two selected eNBs to serve as the DeNB when the at least one of the at least two selected eNBs does not currently support serving the RN as the DeNB, wherein the reconfiguration of an eNB takes into account the functionalities required from the eNB when co-operatively serving the RN.

Thus, the ACA may decide to reconfigure only those parts of the eNB that need to be upgraded when the eNB is serving the RN in co-operation with at least one other eNB. This is advantageous so that each eNB need not be reconfigured in the same way. One eNB may require reconfiguration of several functionalities whereas another eNB may require reconfiguration of only a few functionalities. Thus, time is saved because the reconfiguration of an eNB is adapted to the needs of the eNB individually. The functionalities of the other co-operative eNBs are taken into account when determining which functionalities are needed from the eNB under the reconfiguration process. For example, when handover takes place, the functionalities required from a target DeNB may be different than the functionalities required from a source DeNB.

After at least one eNB has been reconfigured to DeNB in the relay-enhanced communication network, the ACA may perform reconfiguration of the relay-enhanced communication network. The reconfiguration of the network may comprise that radio- and transport-configurations of eNBs and DeNBs are adapted or generated. The ACA responsible may be located at the centralized network element (such as at the O&M) or at the base station (such as at the eNB).

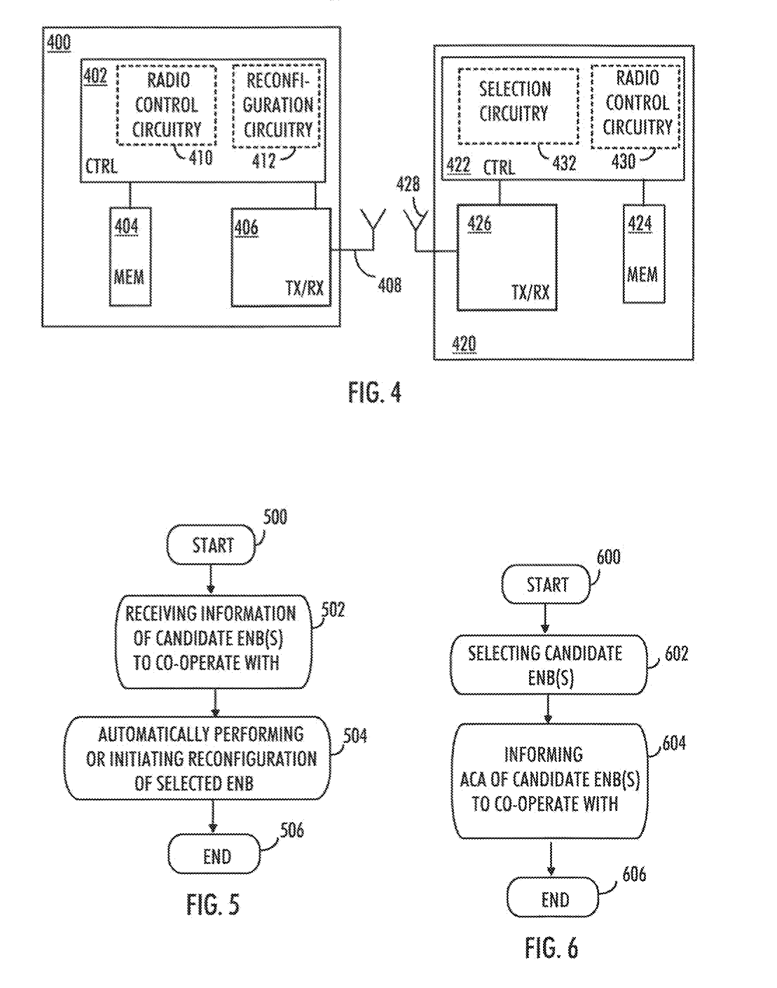

Very general architectures of apparatuses according to embodiments are shown in FIG. 4. FIG. 4 shows only the elements and functional entities required for understanding the apparatuses. Other components have been omitted for reasons of simplicity. The implementation of the elements and functional entities may vary from that shown in FIG. 4. The connections shown in FIG. 4 are logical connections, and the actual physical connections may be different. The connections can be direct or indirect and there can merely be a functional relationship between components. It is apparent to a person skilled in the art that the apparatuses may also comprise other functions and structures.

The apparatus 400 for co-operation in the relay-enhanced communication network may comprise a processor 402. The processor 402 may be implemented with a separate digital signal processor provided with suitable software embedded on a computer readable medium, or with a separate logic circuit, such as an application specific integrated circuit (ASIC). The processor 402 may comprise an interface, such as computer port, for providing communication capabilities. The processor 402 may be, for example, a dual-core processor or a multiple-core processor.

The apparatus 400 may comprise a memory 404 connected to the processor 402. However, memory may also be integrated to the processor 402 and, thus, no memory 404 may be required. The memory 404 may be used in storing information related to the reconfiguration process, such as which parts of the software need to be updated, license related information, etc. The memory may also store information related to the original network planning phase, such as identity of any legacy eNBs. The apparatus 400 may further comprise a transceiver (TRX) 406. The TRX 406 may further be connected to one or more antennas 408 enabling connection to and from an air interface. The interface 406 may receive information from a relay node, wherein the information describes that the RN desires to co-operate with certain candidate eNB. The TRX 406 may also be used sending information to the RN to postpone the co-operation with the selected eNB, or to another network entity, when the current apparatus 400 is incapable of performing the reconfiguration of the selected eNB.

The processor 402 may comprise a radio control circuitry 410 for performing radio control related activities, such as radio resource management, radio access control, etc. The radio control circuitry 410 may also perform measurements related to the traffic situation in the communication network, for example. The radio control circuitry 410 may also perform selection of an eNB among the indicated candidate eNBs, wherein the selected eNB is to be reconfigured to obtain the DeNB functionalities. When doing the selection, prioritization between criteria for selection may take place, as described earlier.

The processor 402 may comprise a reconfiguration circuitry 412 for automatically performing or initiating the reconfiguration of an eNB so that after the reconfiguration the eNB may obtain functionalities which are required from a donor eNB when co-operating with a relay node in the relay-enhanced communication network. As the reconfiguration is performed automatically, there is no user/operator interaction needed for the reconfiguration. The reconfiguration circuitry 412 may perform the configuration process gradually. This may be due to the fact that a verification whether the RN is a valid RN may need to be performed first before the reconfiguration is completed. The verification may be performed by the radio control circuitry 410, for example.

The apparatus 420 for co-operation in the relay-enhanced communication network may comprise a processor 422. The processor 422 may be implemented with a separate digital signal processor provided with suitable software embedded on a computer readable medium, or with a separate logic circuit, such as an application specific integrated circuit (ASIC). The processor 422 may comprise an interface, such as computer port, for providing communication capabilities. The processor 422 may be, for example, a dual-core processor or a multiple-core processor.

The apparatus 420 may comprise a memory 424 connected to the processor 422. However, memory may also be integrated to the processor 422 and, thus, no memory 424 may be required. The memory 424 may be used in storing information related to the selection process, such as which eNBs are selected as the candidate eNBs for the co-operation.

The apparatus 420 may further comprise a transceiver (TRX) 426. The TRX 426 may further be connected to one or more antennas 428 enabling connection to and from an air interface. The interface 426 may transmit information, either directly or indirectly, to an auto configuration apparatus (ACA), wherein the information indicates the selected eNB or the selected candidate eNBs for co-operation. The TRX 426 may also be used in receiving information from the ACA wherein the information may indicate when the apparatus 420 may try to co-operate with the selected eNB. The TRX may also be used in receiving user-related data and transmitting the user-related data onwards towards the end-receiver, such as receiving data from an eNB/UE and transmitting the data to an UE/eNB, respectively.

The processor 422 may comprise a radio control circuitry 430 for performing radio control related activities, such as received signal power strength measurements, access control to connecting UEs, etc.

The processor 422 may comprise a selection circuitry 432 for performing the selection of the eNB with which to co-operate on the basis of the measurement results, for example. The selection circuitry may also select at least one additional eNB so that the selected at least two eNBs serve as candidate eNBs for the co-operation between the apparatus 420 and one of the candidate eNBs.

The apparatus 400 may be the auto configuration apparatus. The apparatus 400 may locate at a base station, at a centralized network element, such as a O&M, NMS, for example. The apparatus 420 may be located in a relay node, for example. As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

FIG. 5 shows a method for reconfiguring a base station in a relay enhanced network. The method starts in step 500. In step 502 the method comprises receiving information of candidate eNBs to co-operate with. This may comprise receiving information about a preference of the relay node to co-operate with the selected base station, or receiving information about at least two candidate eNBs for co-operating with the relay node. If this is the case, the apparatus performing the method of FIG. 5 may select which eNB is to serve the relay node as the donor eNB. The method further comprises in step 504, automatically reconfiguring or initiating the re-configuration of the selected base station when the selected base station does not currently support serving the relay node as the donor eNB. The method ends in step 506.

FIG. 6 shows a method for reconfiguring a base station in a relay enhanced network. The method starts in step 600. In step 602 the method comprises selecting candidate eNBs. The number of the selected candidate eNBs may be one or more. Therefore, in one embodiment, the apparatus performing the method of FIG. 6 may select one base station to co-operate with, wherein the selection is made among at least one base station on the basis of available radio channel condition or other criteria as described above. In step 604, the method comprises informing an auto-configuration apparatus about the candidate eNBs to co-operate with. The information may be about a preference of the relay node to co-operate with the specific selected base station in order for the auto-configuration apparatus to automatically perform the reconfiguration of the selected base station when the selected base station does not currently support serving the relay node as the donor base station. Alternatively, the information may comprise information of the at least two selected base stations so that the ACA may perform the final selection regarding which eNB is to be updated and to co-operate with the relay node as the donor eNB. The method ends in step 606.

The embodiments of the invention offer many advantages. The embodiments prevent manual RN location detection, manual RN identification and manual configuration of eNBs when an operator deploys RNs in the area. This upgrade functionality is aligned with flexible deployment of the relay nodes. When the RN has been deployed somewhere, for instance mounted on a lamp post, the eNB which is to become the DeNB is setup and reconfigured automatically, if the required functionality is not available in the eNB yet. Further, only those eNBs are upgraded to DeNBs that are actually needed by the deployed RNs. By automating the procedure, the costs for configuration of RNs may be reduced and complex reconfiguration when any eNB changes its role may be avoided. Further, memory that is needed to store modules related for DeNB functionality may not need to be used in the other nodes for this purpose and, thus, may be used for other purposes e.g. for larger data buffers in these nodes

The techniques and methods described herein may be implemented by various means. For example, these techniques may be implemented in hardware (one or more devices), firmware (one or more devices), software (one or more modules), or combinations thereof. For a hardware implementation, the apparatuses of FIG. 4 may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus for performing the tasks of FIGS. 1 to 6 comprises interfacing means for receiving, by an auto-configuration apparatus, information about a preference of a relay node to co-operate with a selected base station. The apparatus may further comprise processing means for automatically reconfiguring the selected base station to serve as the donor base station in the relay-enhanced communication network when the selected base station does not currently support serving the relay node as the donor base station.

Embodiments of the invention may be implemented as computer programs in the apparatuses according to the embodiments. The computer programs comprise instructions for executing a computer process for improving co-operation between the relay node and the base station in the relay-enhanced communication network. The computer program may carry out, but is not limited to, the tasks related to FIGS. 1 to 6.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package. The computer program may also be downloaded.

Even though the invention has been described above with reference to an example according to the accompanying drawings, it is clear that the invention is not restricted thereto but can be modified in several ways within the scope of the appended claims. Further, it is clear to a person skilled in the art that the described embodiments may, but are not required to, be combined with other embodiments in various ways.

1. A method comprising:
receiving information about a preference of a relay node to co-operate with a selected base station; and
automatically reconfiguring or initiating the reconfiguration of the selected base station to serve as a donor base station when the selected base station does not currently support serving the relay node as the donor base station.

2. The method of claim 1, wherein the reconfiguration is performed or initiated by the selected base station or by a network element other than the selected base station.

3. The method of claim 1, the method further comprising:
receiving information of at least one additional base station, wherein the at least two selected base stations are candidate base stations for co-operation with the relay node;
selecting which of the candidate base stations is to serve as the donor base station on the basis of at least one of the following reasons related to the at least two selected base stations: indicated radio channel conditions, a current traffic situation, expected positions of further relay nodes, and original network planning; and
automatically reconfiguring or initiating the reconfiguration of the selected base station when the selected base station does not currently support serving the relay node as the donor base station.

4. The method of claim 3, the method further comprising: prioritizing the current traffic situation, expected positions of further relay nodes, and the original network planning over the indicated radio channel conditions when selecting which of the candidate base stations is to serve as the donor base station.

5. The method of claim 1, the method further comprising:
exchanging information related to the selected base station with another network element, when the reconfiguration of the selected base station is not possible, thereby allowing the another network element to reconfigure the selected base station.

6. The method of claim 1, wherein reconfiguring the selected base station comprises at least one of the following: updating a software of the selected base station, re-parameterizing the configuration of the selected base station, activating a license to the software, assigning a new physical cell identity to the selected base station, updating a tracking area of the selected base station, and adjusting antenna orientation of the selected base station.

7. The method of claim 1, the method further comprising:
informing the relay node to restrain from co-operation with the selected base station until the reconfiguration of the selected base station is compete.

8. The method of claim 1, the method further comprising:
reconfiguring or initiating the reconfiguration of the selected base station gradually so that the selected base station is first enabled to obtain knowledge of an identification of at least one relay node in the relay-enhanced communication network;
analyzing the identification of the relay node planning to co-operate with the selected base station in order to verify that the relay node is a valid relay node in the relay-enhanced communication network; and
completing the reconfiguration of the selected base station when the relay node is verified as valid.

9. The method of claim 1, the method further comprising:
receiving information of at least one additional base station, wherein the at least two selected base stations are to co-operatively serve the relay node as the donor base stations; and
automatically reconfiguring or initiating the reconfiguration of at least one of the at least two selected base stations to serve as the donor base stations when the at least one of the at least two selected base stations does not currently support serving the relay node as the donor base station, wherein the reconfiguration of a base station takes into account the functionalities required from the base station when cooperatively serving the relay node.

10. A method comprising:
selecting, by a relay node, a base station to co-operate with, wherein the selection is made among at least one base station on the basis of available radio channel condition; and
informing an auto-configuration apparatus about a preference of the relay node to co-operate with the selected base station in order for the auto-configuration apparatus to automatically reconfigure or initiate the reconfiguration of the selected base station to serve as a donor base station when the selected base station does not currently support serving the relay node as the donor base station.

11. The method of claim 10, the method further comprising:
selecting at least one additional base station, wherein the at least two selected base stations are candidate base stations for co-operation with the relay node; and
informing the auto-configuration apparatus of the candidate base stations in order to allow the auto-configuration apparatus to determine which of the candidate base stations is to serve as the donor base station, and to automatically reconfigure or initiate the reconfiguration of the determined base station when the determined base station does not currently support serving the relay node as the donor base station.

12. An apparatus comprising:
at least one processor and at least one memory including a computer program code, wherein the at least one memory and the computer program code are configured to, with the at least one processor, cause the apparatus at least to:
receive information about a preference of a relay node to co-operate with a selected base station; and
automatically reconfigure or initiate the reconfiguration of the selected base station to serve as a donor base station when the selected base station does not currently support serving the relay node as the donor base station.

13. (canceled)

14. The apparatus of claim 12, the apparatus being further caused to:
receive information of at least one additional base station, wherein the at least two selected base stations are candidate base stations for co-operation with the relay node;
select which of the candidate base stations is to serve as the donor base station on the basis of at least one of the following reasons related to the at least two selected base stations: indicated radio channel conditions, a current traffic situation, expected positions of further relay nodes, and original network planning; and
automatically reconfigure or initiate the reconfiguration of the selected base station when the selected base station does not currently support serving the relay node as the donor base station.

15. The apparatus of claim 14, the apparatus being further caused to:
prioritize the current traffic situation, expected positions of further relay nodes, and the original network planning over the indicated radio channel conditions when selecting which of the candidate base stations is to serve as the donor base station.

16. The apparatus of claim 12, the apparatus being further caused to:
exchange information related to the selected base station with another network element, when the reconfiguration of the selected base station is not possible, thereby allowing the another network element to reconfigure the selected base station.

17. The apparatus of claim 12, wherein reconfiguring the selected base station comprises at least one of the following: updating a software of the selected base station, re-parameterizing the configuration of the selected base station, activating a license to the software, assigning a new physical cell identity to the selected base station, updating a tracking area of the selected base station, and adjusting antenna orientation of the selected base station.

18. (canceled)

19. The apparatus of claim 12, the apparatus being further caused to:
reconfigure or initiate the reconfiguration of the selected base station gradually so that the selected base station is first enabled to obtain knowledge of an identification of at least one relay node in the relay-enhanced communication net-work;
analyze the identification of the relay node planning to cooperate with the selected base station in order to verify that the relay node is a valid relay node in the relay-enhanced communication network; and
complete the reconfiguration of the selected base station when the relay node is verified as valid.

20. The apparatus of claim 12, the apparatus being further caused to:
receive information of at least one additional base station, wherein the at least two selected base stations are to cooperatively serve the relay node as the donor base stations; and
automatically reconfigure or initiate the reconfiguration of at least one of the at least two selected base stations to serve as the donor base stations when the at least one of the at least two selected base stations does not currently sup-port serving the relay node as the donor base station, wherein the reconfiguration of a base station takes into account the functionalities required from the base station when cooperatively serving the relay node.

21. An apparatus comprising:
at least one processor and at least one memory including a computer program code, wherein the at least one memory and the computer program code are configured to, with the at least one processor, cause the apparatus at least to:
select a base station to co-operate with, wherein the selection is made among at least one base station on the basis of available radio channel condition; and
inform an auto-configuration apparatus about a preference of the relay node to co-operate with the selected base station in order for the auto-configuration apparatus to automatically reconfigure or initiate the reconfiguration of the selected base station to serve as a donor base station when the selected base station does not currently support serving the relay node as the donor base station.

22. The apparatus of claim 21, the apparatus being further caused to:
select at least one additional base station, wherein the at least two selected base stations are candidate base stations for co-operation with the relay node; and
inform the auto-configuration apparatus of the candidate base stations in order to allow the auto-configuration apparatus to determine which of the candidate base stations is to serve as the donor base station, and to automatically reconfigure or initiate the reconfiguration of the determined base station when the determined base station does not currently support serving the relay node as the donor base station.

23. (canceled)

24. (canceled)

25. (canceled)

26. (canceled)
